(19) United States
(12) Patent Application Publication
(10) Pub. No.: US 2009/0153468 A1
(43) Pub. Date: Jun. 18, 2009

(54) Virtual Interface System

(75) Inventors: Soh Khim Ong, Singapore (SG); Andrew Yeh Ching Nee, Singapore (SG); Miaolong Yuan, Singapore (SG)

Correspondence Address: HARNESS, DICKEY & PIERCE, P.L.C., P.O. BOX 828, BLOOMFIELD HILLS, MI, 48303, US

(73) Assignee: NATIONAL UNIVERSITY OF SINGAPORE, Singapore (SG)

(21) Appl. No.: 12/084,410

(22) PCT Filed: Oct. 31, 2006
(86) PCT No.: PCT/SG2006/000320

§ 371 Date: Sep. 15, 2008

Related U.S. Application Data
(60) Provisional application No. 60/731,672, filed on Oct. 31, 2005.

(51) Int. Cl. G09G 5/00; H04N 7/18; H04N 5/225

(52) U.S. Cl. 345/156; 348/61; 348/169; 348/E07.085; 348/E05.024

(57) ABSTRACT

The invention relates to a virtual interface system, to a method of providing a virtual interface, and to a data storage medium having stored thereon computer code means for instructing a computer system to execute a method of providing a virtual interface. A virtual interface system comprises a camera; a processor coupled to the camera for receiving and processing video data representing a video feed captured by the camera; a display coupled to the processor and the camera for displaying first and second interface elements superimposed with the video feed from the camera in response to display data from the processor, the second interface element being displayed at a fixed location on the display; wherein the processor tracks a motion action of a user based on the video data received from the camera, controls a display location of the first interface element on the display based on the tracked motion action; and determines a user input based on a relative position of the first and second interface elements on the display.

### FIELD OF INVENTION

The invention relates to a virtual interface system, to a method of providing a virtual interface, and to a data storage medium having stored thereon computer code means for instructing a computer system to execute a method of providing a virtual interface.

### BACKGROUND

A number of systems have been devised to assist users with physical disabilities who are unable to use devices such as a computer with regular input devices such as a keyboard and mouse.

For example, an existing system employs a sensor surface and an electronic pointing device, such as a laser pointer mounted onto a user's head. The user turns his head until the laser pointer points at the portion of the sensor surface that invokes the desired function. However, such a system has the disadvantage of requiring additional hardware, namely the sensor surface.

On the other hand, augmented reality (AR) systems generate a composite view for a user. It is a combination of a real scene viewed by the user, for example, the environment the user is in, and a virtual scene generated by the computer that augments the scene with additional information.

One existing AR system uses a projecting system to project input devices onto a flat surface. User input is achieved by detecting the users' finger movements on the projected devices to interpret and record keystrokes wherein a sensor is provided to detect the users' finger movements. One disadvantage of the second known system is that a projecting system and a projection surface are required for the system to operate, while another disadvantage is that there may not be sufficient area to project the input devices.

Other existing virtual keyboards require relatively large user movements to operate the virtual keyboards, similar to operation of actual keyboards, which poses a problem to handicapped users who can only move portions of their body to a small degree. These known virtual keyboards also require related sensors to detect unique electronic signals corresponding to the portions of the virtual keyboard that are touched.

There is thus a need for a system that seeks to address one or more of the above disadvantages.

### SUMMARY

According to a first aspect of the invention, there is provided a virtual interface system comprising a camera; a processor coupled to the camera for receiving and processing video data representing a video feed captured by the camera; a display coupled to the processor and the camera for displaying first and second interface elements superimposed with the video feed from the camera in response to display data from the processor, the second interface element being displayed at a fixed location on the display; wherein the processor tracks a motion action of a user based on the video data received from the camera, controls a display location of the first interface element on the display based on the tracked motion action; and determines a user input based on a relative position of the first and second interface elements on the display.

The processor may track the motion action of the user based on tracking the relative movement of a reference object captured in the video feed and the camera.

The reference object may comprise a stationary object, and the camera may move under the motion action of the user.

The reference object may be worn by the user and may move under the motion of the user.

The reference object may be a cap attached to the finger of the user.

The camera may be mounted on the user's head.

The first interface element may comprise a keyboard or control panel, and the second interface element may comprise a stylus.

The second interface element may comprise a keyboard or control panel, and the first interface element may comprise a stylus.

According to a second aspect of the invention, there is provided a method of providing a virtual interface, the method comprising the steps of displaying on a display first and second interface elements superimposed with video feed from a camera and in response to display data from a processor, the second interface element being displayed at a fixed location on the display; tracking a motion action of a user based on the video data received from the camera; controlling a display location of the first interface element on the display based on the tracked motion action; and determining a user input based on a relative position of the first and second interface elements on the display.

According to a third aspect of the invention, there is provided a data storage medium having stored thereon computer code means for instructing a computer system to execute a method of providing a virtual interface, the method comprising the steps of displaying on a display first and second interface elements superimposed with video feed from a camera and in response to display data from a processor, the second interface element being displayed at a fixed location on the display; tracking a motion action of a user based on the video data received from the camera; controlling a display location of the first interface element on the display based on the tracked motion action; and determining a user input based on a relative position of the first and second interface elements on the display.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic drawing of an augmented reality (AR) system in accordance with one embodiment of the invention.

FIG. 2 illustrates the relationship between the World Coordinate System and the camera coordinate system of a “Stationary Stylus and Moveable Virtual Keyboard” approach.

FIG. 3 shows a flowchart illustrating an algorithm implemented by the system of FIG. 1.

FIG. 4 is a schematic drawing illustrating an implementation of the “Stationary Stylus And Moveable Virtual Keyboard” approach using the algorithm of FIG. 3.

FIGS. 5A to 5C illustrate tracking of a cap placed on the fingertip of a user in an example embodiment.

FIG. 6 shows the flowchart illustrating an algorithm implemented by the system of FIG. 1.

FIG. 7 is a schematic drawing illustrating an implementation of the “Stationary Virtual Keyboard And Moveable Stylus” approach using the algorithm of FIG. 6.

FIG. 8 shows a flowchart illustrating a method of providing a virtual interface according to an example embodiment.

FIG. 9 shows a schematic diagram illustrating a virtual interface system according to an example embodiment.

FIG. 10 is a schematic drawing illustrating a computer system for implementing the described method and systems.

### DETAILED DESCRIPTION

The AR systems and methods described herein can provide a virtual user interface in which only slight user motion action is required to operate the user interface.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “calculating”, “determining”, “generating”, “tracking”, “capturing” outputting or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

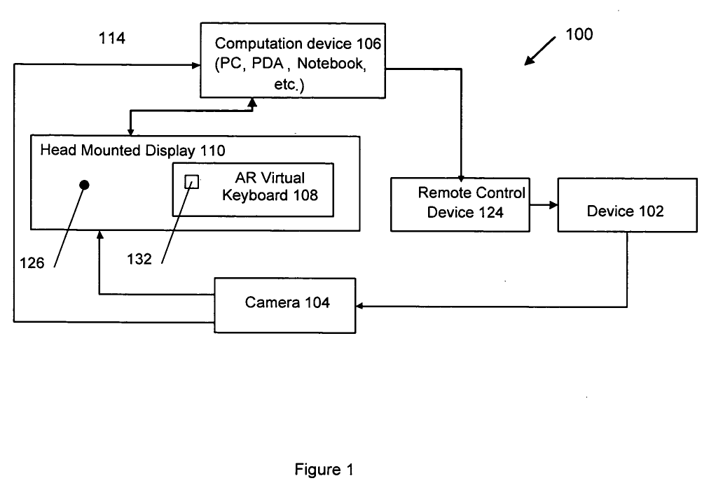

FIG. 1 is a schematic drawing of an augmented reality (AR) system 100 in accordance with one embodiment of the invention.

The AR system 100 comprises a camera 104, a computation device 106, a head mounted display 110 and a remote control device 124 for an external device 102. The camera 104 is coupled to both the computation device 106 and the head mounted display 110. The computation device 106 is coupled to the head mounted display 110 and to the remote control device 124.

The computation device 106 used in this embodiment is a personal computer. It will be appreciated that other devices used for the computation device 106, include, but are not limited to, a notebook or a personal digital assistant.

The camera 104 used in this embodiment is a standard IEEE FireFly camera that communicates with the computation device 106 through Visual C++ and OpenGL software. It will be appreciated that other devices used for the camera 104, include but are not limited to, a USB web camera.

The head mounted display 110 used in this embodiment is a MicroOptical Head Up Display SV-6. It will be appreciated that other devices used for the head mounted display 110, include, but are not limited to, a Shimadzu Dataglass 2/A or a Liteye LE500 display.

In this embodiment, the head mounted display 110 and the camera 104 are worn by a user on the user's head using suitable mounting gear. For example, the head mounted display 110 can be mounted on a spectacle type frame, while the camera 104 may be mounted on a head band. The camera 104 thus shares substantially the same point of view as the user, while the head mounted display 110 is positioned in front of at least one of the user's eyes.

It will be appreciated that the computation device 106, the head mounted display 110 and the camera 104, may be provided as an integrated unit in a different embodiment.

The computation device 106 receives a first signal 114 comprising data representative of the video feed from the camera 104 and generates a virtual object in the form of a virtual keyboard 108 or a virtual control panel and a stylus 126 and controls the display of the virtual keyboard 108 and the stylus 126 on the head mounted display 110. The head mounted display 110 allows the user to also view an environment around him or her. Thus with the virtual keyboard 108 and the stylus 126 being displayed in the field of view of the head mounted display 110, an augmented image comprising virtual objects and real objects is formed, whereby the user perceives that the virtual keyboard 108 and the stylus 126 “appear” as part of the environment.

Alternatively or additionally, the computation device 106 can control another display device (not shown) such as a normal computer screen. The other display device displays similar content as the head mounted display 110. It will be appreciated that the user may use the AR system 100 based on the display on the other display device depending on the comfort level and preference of the individual.

The virtual keyboard 108 and the stylus 126 act as interface elements of a virtual user interface that facilitates user input to the computation device 106 and, via the computation device 106, to other peripherally connected devices, such as the remote control device 124 for control of the external device 102.

Interaction between user input and the virtual keyboard 108 is established by moving the stylus 126 and the virtual keyboard 108 relative to each other so that the stylus 126 is displayed over an active key 132 of the virtual keyboard 108. The virtual keyboard 108 comprises a plurality of active keys 132, where each key 132 performs an associated function, such as sending a signal to a remote control unit 124 for the remote control unit 124 to control an external device 102, for example, but not limited to change the channel of a television set. When the signal is used to control computer applications in a computer, for example, but not limited to Microsoft Word, the head mounted display 110 is not required and the virtual keyboard can be displayed on this normal computer screen. When the stylus 126 is positioned over the active key 132 of the virtual keyboard 108 and remains at approximately the same location over a short interval of time, the function associated with the active key 132 will be activated. In one embodiment, referred to as the “stationary stylus and moveable virtual keyboard” approach, the stylus 126 is a stationary element in the field of view of the head mounted display 110, while the virtual keyboard 108 moves across the field of view of the head mounted display 110 in response to user input, such as movement of the user's head. In another embodiment, referred to as the “stationary virtual keyboard and moveable stylus” approach, the virtual keyboard 108 is a stationary element in the field of view of the head mounted display 110, while the stylus 126 moves across the virtual keyboard 108 in response to user input, such as movement of the user's head or movement of a user's finger.

Stationary Stylus and Moveable Virtual Keyboard

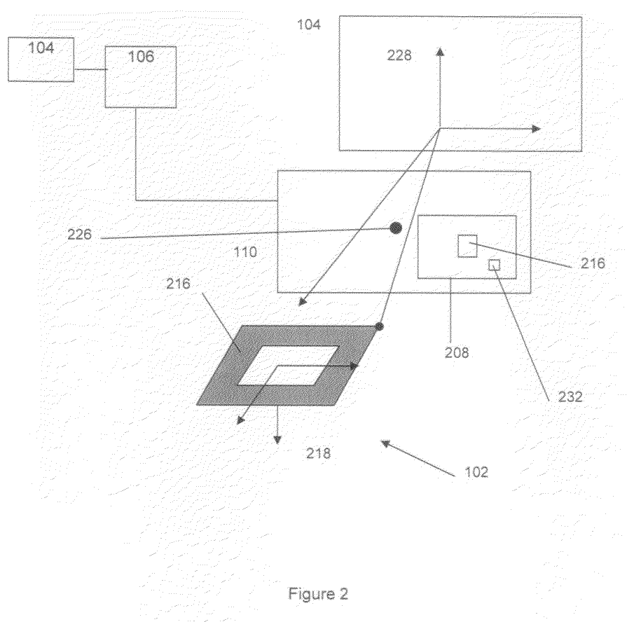

With reference to FIG. 2, in the first approach, a stylus 226 is a stationary element in the field of view of the head mounted display 110, while a virtual keyboard 208 moves across the field of view of the head mounted display 110 in response to user input.

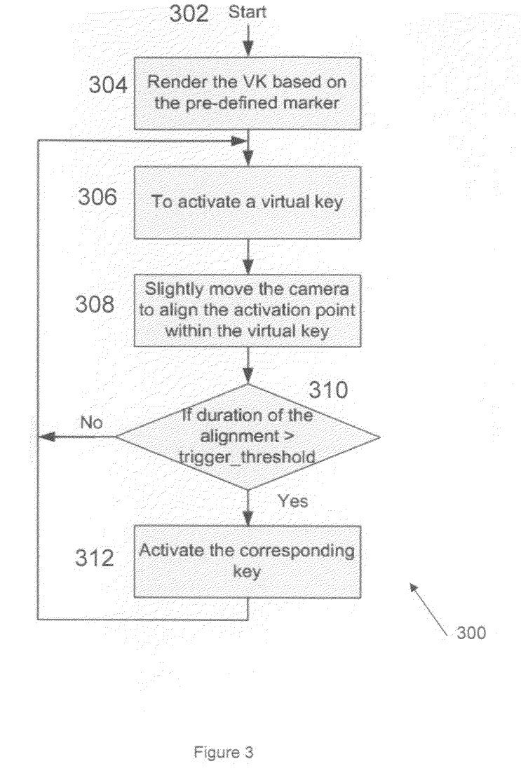

A reference marker 216, which is of a shape corresponding to a pre-defined shape recognised by an algorithm 300 (FIG. 3) implemented in the computation device 106, is placed at a convenient location in the environment 102. The computation device 106 uses the marker 216 as a reference to define world coordinate system (WCS) axes 218, whereby the algorithm 300 (FIG. 3) implemented in the computation device 106 subsequently aligns a camera coordinate system (CCS) axes 228 to the WCS axes 218. Further, the reference marker 216 serves as an anchor to which the virtual keyboard 208 will be located when the reference marker 216 is sensed by the camera 104. Thus, the virtual keyboard 208 moves across the field of view of the head mounted display 110 when the camera 104 is moved in response to user input, for example, from head movement with a head mounted camera 104.

To form the augmented image where the virtual keyboard 208 is superimposed over the reference marker 216, the algorithm 300 (FIG. 3) of the computation device 106 employs a pinhole camera model given as follows:

ρm=A[R|t]M (1)

where m=(u,ν,1)^{T} and M=(X,Y,Z,1)^{T}, which are respectively an image point and its corresponding 3D point in the WCS 218 and represented by homogeneous vectors. ρ is an arbitrary factor, while (R, t) is the rotation and translation vector matrix that relate the WCS 218 to the CCS 228 and is generally called the extrinsic parameter. A is the camera 104 intrinsic matrix.

While remaining on FIG. 2, the operation of the “Stationary Stylus And Moveable Virtual Keyboard” approach is described with reference to the flowchart used by the algorithm 300 of FIG. 3.

The algorithm 300 (FIG. 3), in this embodiment, is encoded using ARToolKit and Visual C++ software in the computation device 106 (FIG. 1). It will be appreciated that other software can also be used to encode the algorithm 300 (FIG. 3).

At the start 302 (FIG. 3), the stylus 226 is displayed at a pre-programmed location in the field of view of the head mounted display 110. The stylus 226 remains stationary during the AR system operation.

In step 304 (FIG. 3), the camera 104 is moved until the reference marker 216 is sensed by the camera 104. When the algorithm 300 (FIG. 3) detects that the camera 104 has captured the reference marker 216, the algorithm 300 (FIG. 3) will superimpose the virtual keyboard 208 over where the reference marker 216 is seen by the user through the head mounted display 110, thereby forming an augmented image. The virtual keyboard 208 moves in the field of view of the head mounted display 110 correspondingly with movement of the camera 104 and will continue to be displayed in the field of view of the head mounted display 110 as long as the camera 104 captures the reference marker 216.

Step 306 (FIG. 3) involves user selection of one of the plurality of active keys 232 within the virtual keyboard 208. This is achieved by moving the camera 104, which in turn moves the virtual keyboard 208, until the stylus 226 is in proximity within the virtual keyboard 208.

In step 308 (FIG. 3), slight movements are made to the camera 104 so that the stylus 226 is aligned within the active key 232 that the user has selected. In step 310 (FIG. 3), the algorithm 300 (FIG. 3) determines the duration the stylus 226 has remained over the selected active key 232 and checks whether the duration has exceeded a threshold level. If the duration has exceeded the threshold level, such as 0.5 to 1 second, then step 312 (FIG. 3) occurs wherein the stylus 226 activates the selected active key 232 and invokes the functionality associated with the active key 232. On the other hand, if the duration is less than the threshold level, then the algorithm 300 (FIG. 3) returns to step 306 where the algorithm 300 (FIG. 3) repeats steps 306 to 310 (FIG. 3).

The threshold level can be easily changed and customised to the dexterity of the user by suitably modifying the algorithm 300 (FIG. 3).

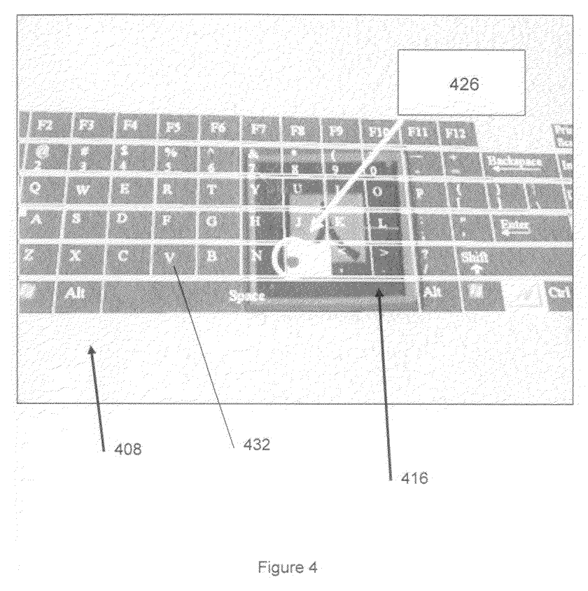

FIG. 4 illustrates an implementation of the “Stationary Stylus And Moveable Virtual Keyboard” approach using the algorithm 300 (FIG. 3).

In FIG. 4, the AR system has created a stylus 426, which remains stationary during the AR system operation, in the form of a circular-shaped selector cursor point. The projection of the stylus 426 can be calculated by setting the Z coordinate in Equation (1) to be zero, assuming the intrinsic camera parameters are known.

A head mounted device (not shown) with a camera has been moved so that the camera captures a reference marker 416. After the camera captures the reference marker 416; a virtual keyboard in the form of a ‘qwerty’ format keyboard 408 is superimposed over the reference marker 416. It will be appreciated that other keyboard formats that can be superimposed, include but are not limited to, a mobile phone keypad. When a user moves the head mounted device (not shown), for example, by moving his head, the display of the virtual keyboard 408 will move correspondingly while the stylus 426 remains stationary.

An augmented image has thus been formed, whereby the user wearing the head mounted device (not shown) will perceive that the virtual objects, namely the stylus 426 and the virtual keyboard 408, “appear” as part of the user's environment as the user peers into a head mounted display positioned over at least one of the user's eyes.

The virtual keyboard displayed in the head mounted device (not shown) has been moved until the stylus 426 is displayed over one of the active keys 432, the letter ‘M’. By allowing the stylus 426 to remain over the letter ‘M’ longer than a threshold level, such as 0.5 to 1 second, the letter ‘M’ will be typed into a word processor software (not shown).

Since the AR system tracks a motion action (head movement) of the user based on the video data received from the camera, controls a display location of the virtual keyboard 408 on the display based on the tracked motion action and determines the user input based on a relative position of the virtual keyboard 408 and the stylus 426 on the display, the AR system can be arranged such that only slight motion (head movement) is required to operate the virtual keyboard 408.

The functions associated with the virtual keyboard 408 can be programmed to include controlling electronic items, such as TVs, fans, and to access computer applications, such as sending emails.

Stationary Virtual Keyboard and Moveable Stylus

Returning to FIG. 1, in the second approach, the virtual keyboard 108 is a stationary element in the field of view of the head mounted display 110, while the stylus 126 moves across the virtual keyboard that is displayed in the field of view of the head mounted display 110 in response to user input.

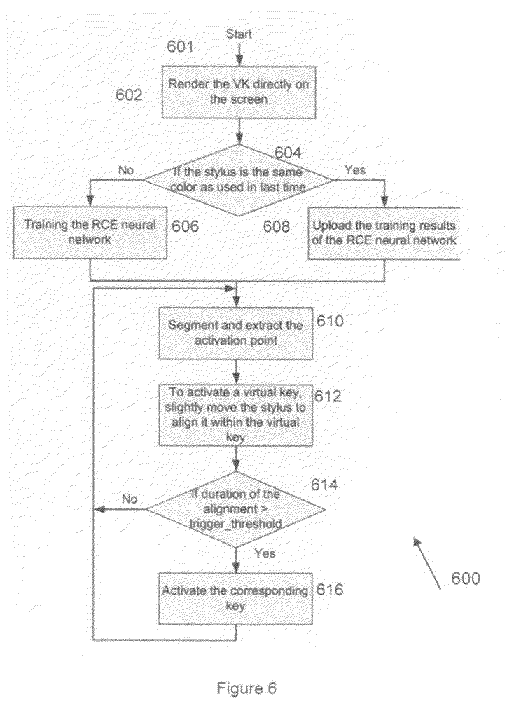

In the second approach, a tracking algorithm 600 (FIG. 6) employed by the computation device 106 is, for example, configured to only recognise and track objects of a predetermined colour. This ensures that any other objects sensed by the camera 104 are not tracked by the AR system 100.

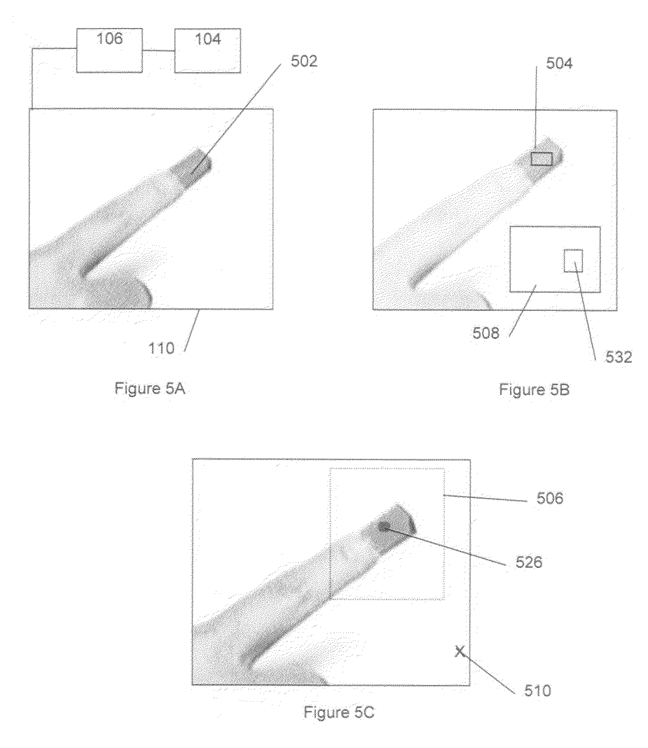

FIGS. 5A to 5C illustrate a small coloured cap 502 placed on a user's finger, as viewed by a user looking through the head mounted display 110. The tracking algorithm 600 (FIG. 6) is configured to recognise the colour of the cap 502 and thereby track the cap 502.

While remaining on FIGS. 5A to 5C, the operation of the “Stationary Virtual Keyboard And Moveable Stylus” approach is described with reference to the flowchart used by the algorithm 600 of FIG. 6.

The algorithm 600 (FIG. 6), in this embodiment, is encoded using ARToolKit and Visual C++ software in the computation device 106 (FIG. 1). It will be appreciated that other software can also be used to encode the algorithm 600 (FIG. 6).

The algorithm (FIG. 6) initiates at step 601. At step 602 (FIG. 6), a virtual keyboard 508 is displayed at a pre-programmed fixed location in the field of view of the head mounted display 110 as shown in FIG. 5B. An augmented image is thus formed, whereby the user perceives through the head mounted display 110 that the virtual keyboard 508 is part of the user's environment, where the virtual keyboard 508 remains stationary.

Data regarding the cap 502 is retrieved from the camera 104 in step 604 (FIG. 6) and analysed to determine whether the cap 502 has the same colour characteristics as the physical object tracked in an earlier instance.

If the cap 502 does not share the same colour characteristics, then the algorithm 600 (FIG. 6) moves to step 606 (FIG. 6), where a Restricted Coulomb Energy (RCE) neural network employed by the algorithm 600 (FIG. 6) is trained to “recognise” the cap 502 colour and enable the algorithm 600 (FIG. 6) to subsequently track the position of the cap 502.

In the training procedure, the algorithm 600 (FIG. 6) specifies a training region 504 on the cap 502, as shown in FIG. 5B. Training data is then obtained from the training region 504. From the training data, a stylus 526 is formed around the centre of the training region 504 as shown in FIG. 5C. Although the stylus 526 is a virtual object, the user will perceive the stylus 526 to be part of the user's environment. The stylus 526 will also move when the cap 502 is moved.

On the other hand, if the colour of the cap 502 shares the same colour characteristics as the physical object tracked in an earlier instance, the algorithm 600 (FIG. 6) proceeds to step 608 (FIG. 6), where the training results obtained from the earlier instance are reused. This provides the advantage of automatic initialisation and saving processing time.

In step 610 (FIG. 6), the algorithm 600 (FIG. 6) undergoes a segmentation procedure. In this segmentation procedure, each frame captured by the camera 104 is segmented. Each segmented frame has a localised search window 506 with a centre being the location of the stylus 526 in the previous frame. Data representing the colour values of the cap 502 within the localised search window 506 is input into the trained RCE neural network and the RCE neural network then outputs the segmentation results. The segmentation results are grouped using a group connectivity algorithm. From the segmentation results, an activation point will be extracted which will be projected onto the display 110 to form the stylus 526 seen by the user at a particular instant. In this manner, the cap 502 will be continuously tracked as the user's finger moves with corresponding movement of the stylus 526 seen by the user. As tracking is restricted to the localised search window 506, substantially real-time execution of the algorithm 600 (FIG. 6) is achieved.

Step 612 (FIG. 6) involves user selection of one of the plurality of active keys 532 within the virtual keyboard 508. This is achieved by moving the cap 502, which in turn moves the stylus 526, until the stylus 526 is in proximity with the virtual keyboard 508.

In step 614 (FIG. 6), the algorithm 600 (FIG. 6) determines the duration the stylus 526 has remained over the selected active key 532 (FIG. 5B) and checks whether the duration has exceeded a threshold level. If the duration has exceeded the threshold level, such as 0.5 to 1 second, then step 612 (FIG. 6) occurs wherein the stylus 526 activates the selected active key 532 (FIG. 5B) and invokes the functionality associated with the active key 532. On the other hand, if the duration is less than the threshold level, then the algorithm 600 (FIG. 6) returns to step 610 (FIG. 6) where the algorithm 600 (FIG. 6) repeats steps 610 to 614.

The threshold level can be easily changed and customised to the dexterity of the user by suitably modifying the algorithm 600 (FIG. 6).

It will be appreciated that other objects of a different shape and colour can also be used for the algorithm 600 (FIG. 6) to track and project the stylus 526 onto.

Turning to FIG. 6, the user is only required to execute the training procedure in step 606 once. When the training procedure is completed, the training results will be saved automatically. Subsequently, when the user initiates the algorithm 600 using the same physical object for projecting the stylus upon, the algorithm 600 will automatically load the training results in step 608.

The user can also choose to re-execute the training procedure of step 606 to obtain better results, for example if the lighting condition changes. The new training results will be saved automatically.

Turning to FIGS. 5A to 5C, in the event that the stylus 526 is moved too quickly so that it is no longer sensed by the camera 104, the last tracked position of the stylus 526 will be automatically recorded and displayed on the head mounted display 110 as a cursor point 510 by the algorithm 600 (FIG. 6). The user only needs to move the cap 502 so that it is within the boundary of the head mounted display 110 and in proximity with the cursor point 510 whereby the algorithm 600 (FIG. 6) will realign the cursor point 510 with the cap 502 and subsequently continue tracking the stylus 526.

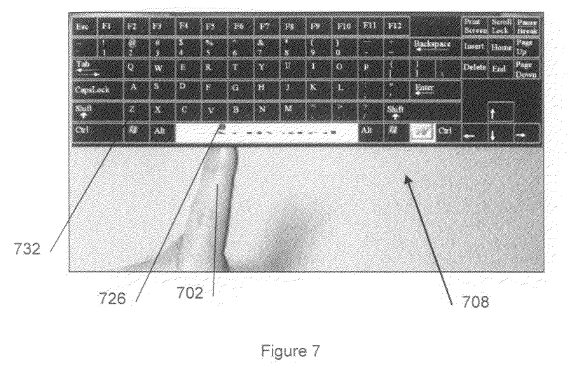

FIG. 7 illustrates an implementation of the “Stationary Virtual Keyboard And Moveable Stylus” approach where selection of an active key 732 on a virtual keyboard 708 is achieved by moving a user's finger 702 to be within the area of the desired active key 732.

In FIG. 7, the AR system has created the virtual keyboard 708, which remains stationary during the AR system operation.

A head mounted device (not shown) with a camera has been positioned so that the camera senses the user's finger 702 which has a cap placed on the fingertip. A stylus 726 will be projected on the cap in accordance with the algorithm 600 (FIG. 6) described above. By allowing the stylus 726 to remain over the spacebar of the virtual keyboard 708 longer than a threshold level, such as 0.5 to 1 second, the spacebar will be activated.

Since the AR system tracks a motion action (finger movement) of the user based on the video data received from the camera, controls a display location of the stylus 726 on the display based on the tracked motion action and determines the user input based on a relative position of the virtual keyboard 708 and the stylus 726 on the display, the AR system can be arranged such that only slight motion (finger movement) is required to operate the virtual keyboard 708.

It will be appreciated that in different embodiments in this approach, the camera may not be head mounted, but may be stationary placed at a location so that the object worn by the user, such as the cap attached to a finger, is within the field of view of the camera.

The functions associated with the virtual keyboard 708 can be programmed to include controlling electronic items, such as TVs, fans, and to access computer applications, such as sending emails.

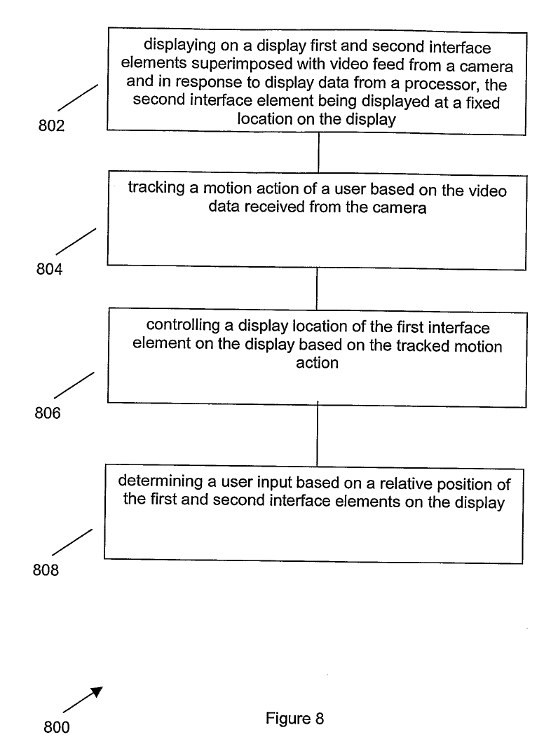

FIG. 8 shows a flowchart 800 illustrating a method of providing a virtual interface according to an example embodiment. At step 802, first and second interface elements are displayed on a display superimposed with video feed from a camera and in response to display data from a processor, the second interface element being displayed at a fixed location on the display. At step 804, a motion action of a user is tracked based on the video data received from the camera. At step 806, a display location of the first interface element on the display is controlled based on the tracked motion action. At step 808, a user input is determined based on a relative position of the first and second interface elements on the display.

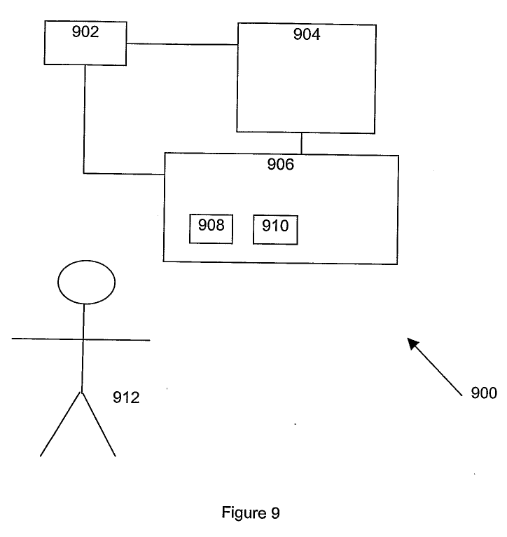

FIG. 9 shows a schematic diagram illustrating a virtual interface system 900 according to an example embodiment. The system 900 comprises a camera 902 and a processor 904 coupled to the camera 902 for receiving and processing video data representing a video feed captured by the camera 902. The system 900 further comprises a display 906 coupled to the processor 904 and the camera 902 for displaying first and second interface elements 908, 910 superimposed with the video feed from the camera 902 in response to display data from the processor 904, the second interface element 910 being displayed at a fixed location on the display 906. The processor 904 tracks a motion action of a user 912 based on the video data received from the camera 902, controls a display location of the first interface element 908 on the display 906 based on the tracked motion action; and determines a user input based on a relative position of the first and second interface elements 908, 910 on the display 906.

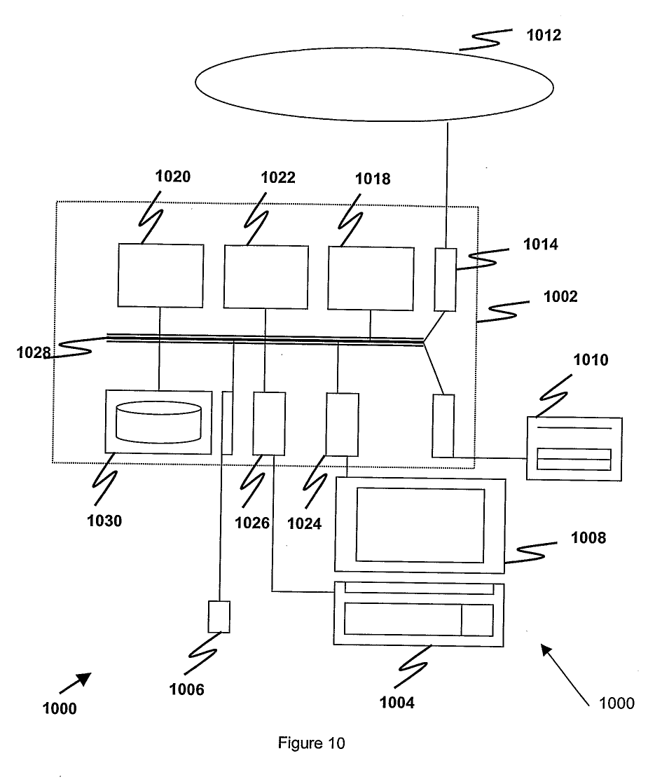

The method and system of the above embodiments can be implemented on a computer system 1000, schematically shown in FIG. 10. It may be implemented as software, such as a computer program being executed within the computer system 1000, and instructing the computer system 1000 to conduct the method of the example embodiment.

The computer system 1000 comprises the computer module 1002, input modules such as a keyboard 1004 and mouse 1006 and a plurality of output devices such as a display 1008, and printer 1010.

The computer module 1002 is connected to a computer network 1012 via a suitable transceiver device 1014, to enable access to e.g. the Internet or other network systems such as Local Area. Network (LAN) or Wide Area Network (WAN).

The computer module 1002 in this embodiment includes a processor 1018, a Random Access Memory (RAM) 1020 and a Read Only Memory (ROM) 1022. The computer module 1002 also includes a number of Input/Output (I/O) interfaces, for example I/O interface 1024 to the display 1008, and I/O interface 1026 to the keyboard 1004.

The components of the computer module 1002 typically communicate via an interconnected bus 1028 and in a manner known to the person skilled in the relevant art.

The application program is typically supplied to the user of the computer system 1000 encoded on a data storage medium such as a CD-ROM or flash memory carrier and read utilising a corresponding data storage medium drive of a data storage device 1030. The application program is read and controlled in its execution by the processor 1018. Intermediate storage of program data may be accomplished using RAM 1020.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A virtual interface system comprising
a camera;
a processor coupled to the camera for receiving and processing video data representing a video feed captured by the camera;
a display coupled to the processor and the camera for displaying first and second interface elements superimposed with the video feed from the camera in response to display data from the processor, the second interface element being displayed at a fixed location on the display;
wherein the processor tracks a motion action of a user based on the video data received from the camera, controls a display location of the first interface element on the display based on the tracked motion action; and identifies a user input selection based on determining that a duration during which the first and second interface elements remain substantially at a constant relative lateral position with reference to a display plane of the display exceeds a threshold value.

2. The system as claimed in claim 1, wherein the processor tracks the motion action of the user based on tracking relative movement of a reference object captured in the video feed and the camera.

3. The system as claimed in claim 2, wherein the reference object comprises a stationary object, and the camera is moved under the motion action of the user.

4. The system as claimed in claim 2, wherein the reference object is worn by the user and is moved under the motion of the user.

5. The system as claimed in claim 4, wherein the reference object is a cap attached to the finger of the user.

6. The system as claimed in claim 1, wherein the camera is mounted on the user's head.

7. The system as claimed in claim 1, wherein the first interface element comprises a keyboard or control panel, and the second interface element comprises a stylus.

8. The system as claimed in claim 1, wherein the second interface element comprises a keyboard or control panel, and the first interface element comprises a stylus.

9. A method of providing a virtual interface, the method comprising the steps of
displaying on a display first and second interface elements superimposed with video feed from a camera and in response to display data from a processor, the second interface element being displayed at a fixed location on the display;
tracking a motion action of a user based on the video data received from the camera;
controlling a display location of the first interface element on the display based on the tracked motion action; and
identifying a user input selection based on determining that a duration during which the first and second interface elements remain substantially at a constant relative lateral position with reference to a display plane of the display exceeds a threshold value.

10. A data storage medium having stored thereon computer code means for instructing a computer system to execute a method of providing a virtual interface, the method comprising the steps of
displaying on a display first and second interface elements superimposed with video feed from a camera and in response to display data from a processor, the second interface element being displayed at a fixed location on the display;
tracking a motion action of a user based on the video data received from the camera;
controlling a display location of the first interface element on the display based on the tracked motion action; and
identifying a user input selection based on determining that a duration during which the first and second interface elements remain substantially at a constant relative lateral position with reference to a display plane of the display exceeds a threshold value.
